(19) United States
(12) Patent Application Publication
(10) Pub. No.: US 2013/0103379 A1
(43) Pub. Date: Apr. 25, 2013

(54) APPARATUS AND METHOD FOR VERIFYING INTEROPERABILITY BETWEEN APPLICATION SOFTWARE AND AUTOSAR SERVICE

(71) Applicants: Hyun-Soon NAM, Daejeon (KR); Ki-Soon SUNG, Daejeon (KR); Tae-Man HAN, Daejeon (KR)

(72) Inventors: Hyun-Soon NAM, Daejeon (KR); Ki-Soon SUNG, Daejeon (KR); Tae-Man HAN, Daejeon (KR)

(73) Assignee: ELECTRONICS AND ELECOMMUNICATIONS RESEARCH INSTITUTE, Daejeon-City (KR)

(21) Appl. No.: 13/615,200

(22) Filed: Sep. 13, 2012

(30) Foreign Application Priority Data
Oct. 20, 2011 (KR) KR10-2011-0107583
Jun. 25, 2012 (KR) KR10-2012-0067810

(51) Int. Cl. G06F 9/45

(52) U.S. Cl. 703/22

(57) ABSTRACT

The present invention relates to an apparatus and method for verifying interoperability between application software and AUTOSAR services. The apparatus includes an AUTOSAR interoperability configuration unit configured to configure an interoperability relationship between AUTOSAR service components defined to provide the AUTOSAR services and the components of the application software for an Electronic Control Unit (ECU) performing functions requested by the application software and a simulation unit configured to perform simulations in order to verify whether the interoperated AUTOSAR service components and the components of the application software are normally driven or not based on scheduled task timing.

### CROSS-REFERENCE(S) TO RELATED APPLICATIONS

This application claims priority to Korean Patent Application Nos. 10-2011-0107583 and 10-2012-0067810, filed on Oct. 20, 2011 and Jun. 25, 2012, respectively, which are incorporated herein by reference in their entirety.

### BACKGROUND OF THE INVENTION

1. Field of the Invention

Exemplary embodiments of the present invention relate to an apparatus and method for verifying interoperability between application software and AUTomotive Open System ARchitecture (AUTOSAR) services; and, particularly, to an apparatus and method for verifying application software including AUTOSAR service components that are specified in AUTOSAR, that is, the standard of a vehicle electric vehicle SW platform architecture.

2. Description of Related Art

As the electrical and electronic structure of a vehicle gradually becomes complicated, the amount of software for controlling the electrical and electronic structure and the degree of complexity of the software also increases. Accordingly, the time taken to develop software also increases, and the probability that software may be defective also increases. Cases where sold vehicles are recalled owing to defective software continue to be frequently reported. Furthermore, with the rapid development of semiconductor and computing technology, component manufactures for producing electric and electronic products for vehicles are producing new products having improved performance in a short cycle. For this reason, automobile makers also have to update software for vehicles frequently.

As the issues of safety and productivity increase in the automobile industry, there is an increasing need for a standardized software platform which guarantees reliability and reusability. The AUTOSAR standard is a software standard platform for vehicle electric devices which has been developed for the purpose of the reliability and reusability. Lots of automobile companies concentrate all energy on developing commercial vehicles on which the platform developed based on the AUTOSAR standard is mounted. The AUTOSAR standard is mounted on Electronic Control Units (ECUs), that is, basic units of vehicle control. The ECUs include Basic SoftWare (B SW) modules configured to perform functions, the components of the application software operated over the BSW module, and a RunTime Environment (RTE) configured to support communication between the BSW module and the components of the application software. Some of the BSW modules provide AUTOSAR services specified in the AUTOSAR standard. AUTOSAR services provided by the BSW modules support that higher application levels and the standard function of the BSW module are used and also define a standard interface for various types of AUTOSAR services. Accordingly, a user who tries to design an automobile application based on the AUTOSAR standard may embody automobile application software of a high quality using various and standardized AUTOSAR services provided by the AUTOSAR standard.

A method of simulating the embodied automobile application software includes designing software architecture in a system configuration step, designing the internal behavior of the software architecture, importing the results, developing application logic based on the imported results, and verifying the developed application logic using a simulation tool.

In relation to the method, Korean Patent Laid-Open Publication No. 10-2009-0056071, entitled “AUTOSAR Service System for Exchangeability and Easy Assembly”, discloses technology for determining whether a developed ECU and application are qualified to be registered or not in response to a request that the developed ECU and application be registered over a wired/wireless communication network. This method is problematic in that it is difficult to debug and verify execution timing with the AUTOSAR platform on ECUs.

### SUMMARY OF THE INVENTION

An embodiment of the present invention is directed to an apparatus and method for verifying interoperability between application software and the AUTOSAR services specified in AUTOSAR, that is, the standard of a vehicle electric vehicle SW platform architecture, which verify whether an interoperability relationship between the AUTOSAR services and application software developed by a developer is normally driven or not based on scheduled task timing so that the application software can efficiently use the AUTOSAR services.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for verifying interoperability between application software and AUTOSAR services includes an AUTOSAR interoperability configuration unit configured to configure an interoperability relationship between AUTOSAR service components defined to provide the AUTOSAR services and the components of the application software for Electronic Control Units (ECUs) performing functions requested by the application software, and a simulation unit configured to perform simulations in order to verify whether the interoperated AUTOSAR service components and the components of the application software are normally driven or not based on scheduled task timing.

The AUTOSAR interoperability configuration unit may include an AUTOSAR system configuration unit configured to design the application software and an AUTOSAR ECU configuration unit configured to extract information on the ECU from the designed application software and design the ECU based on the extracted information.

The AUTOSAR system configuration unit may include an application software port setting unit configured to set the port of the designed application software in order to connect the AUTOSAR service components with the components of the application software.

The AUTOSAR system configuration unit may include an interface mapping unit configured to map an AUTOSAR standard service interface to the port of the components of the application software.

The AUTOSAR ECU configuration unit may include an AUTOSAR service port setting unit configured to set the port of the defined AUTOSAR service components in order to connect the AUTOSAR service components with the components of the application software and a connector configuration unit configured to configure a connector for connecting the port of the AUTOSAR service components with the port of the components of the application software.

The AUTOSAR ECU configuration unit may include an instance generation unit configured to generate an instance of an AUTOSAR service component selected for each ECU and a source generation unit configured to generate a source into which an execution attribute value of the generated instance has been incorporated and provide the generated source to the simulation unit.

The simulation unit schedules task timing for each of the internal behaviors of the components of the application software and the AUTOSAR service components based on an AUTOSAR service library operation unit for storing information necessary to operate the AUTOSAR service components and performs simulations based on the scheduled task timings.

In accordance with another embodiment of the present invention, a method of verifying interoperability between application software and AUTOSAR services includes configuring an interoperability relationship between AUTOSAR service components defined to provide the AUTOSAR services and components of the application software for ECUs performing functions requested by application software and performing simulations in order to verify whether the interoperated AUTOSAR service components and the components of the application software are normally driven or not based on scheduled task timing.

Here, configuring an interoperability relationship between AUTOSAR service components defined to provide the AUTOSAR services and the components of the application software for an ECU performing functions requested by application software may include designing the application software and extracting information on the ECU from the designed application software and designing the ECU based on the extracted information.

Here, designing the application software may include setting the port of the designed application software in order to connect the AUTOSAR service components with the components of the application software and mapping an AUTOSAR standard service interface to the port of the components of the application software.

Here, extracting information on the ECU from the designed application software and designing the ECU based on the extracted information may include setting the port of the defined AUTOSAR service components in order to connect the AUTOSAR service components with the components of the application software; configuring a connector for connecting the port of the AUTOSAR service components with the port of the components of the application software; generating an instance of an AUTOSAR service component selected for each ECU; and generating a source into which an execution attribute value of the generated instance has been incorporated and providing the generated source.

Here, performing simulations in order to verify whether the interoperated AUTOSAR service components and components of the application software are normally driven or not based on scheduled task timing may include scheduling task timing for each of internal behaviors of the components of the application software and the AUTOSAR service components based information necessary to operate the AUTOSAR service components and performing the simulations based on the scheduled task timings.

### BRIEF DESCRIPTION OF THE DRAWINGS

FIG. 1 is a diagram illustrating an AUTOSAR software architecture embodied in an ECU in accordance with the AUTOSAR standard.

FIG. 2 is a schematic block diagram showing the configuration of an apparatus for verifying interoperability between application software and AUTOSAR services in accordance with the present invention.

FIG. 3 is a schematic block diagram showing the configuration of an AUTOSAR interoperability configuration unit which is adopted in the apparatus for verifying interoperability between application software and AUTOSAR services in accordance with the present invention.

FIG. 4 is a schematic block diagram showing the configuration of a simulation unit which is adopted in the apparatus for verifying interoperability between application software and AUTOSAR services in accordance with the present invention.

FIG. 5 is a flowchart illustrating a method of verifying interoperability between application software and AUTOSAR services in accordance with the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In the AUTOSAR standard, standardization is performed with three topics; an AUTOSAR software architecture, an application interface, and development methodology. In particular, in the AUTOSAR software architecture field, BSW, that is, a function used by automobile applications in common is standardized.

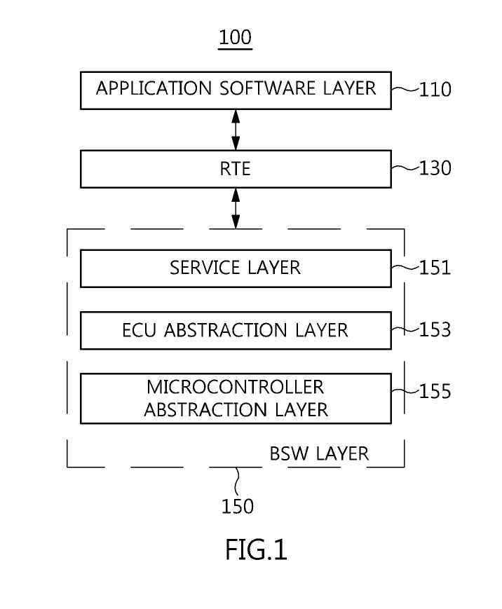

FIG. 1 is a diagram illustrating the AUTOSAR software architecture 100 embodied in an ECU in accordance with the AUTOSAR standard.

Referring to FIG. 1, the AUTOSAR software architecture 100 embodied in an ECU has a hierarchical architecture that is chiefly classified into an application software layer 110, an RTE 130, and a BSW (Basic SoftWare) layer 150. From among them, the BSW layer 150 includes a service layer 151, an ECU abstraction layer 153, and a microcontroller abstraction layer 155.

The application software layer 110 is placed at the top of the AUTOSAR software architecture 100, and it describes the modulated components of application software, ports, interfaces, and internal operations. The embodiment of the application software layer 110 is not handled in the AUTOSAR standard and is embodied independent of a lower hardware layer, such as a microcontroller.

The runtime environment 130 functions to separate higher software components and basic software/hardware from each other by providing a hardware-independent layer for the BSW layer 150, that is, a lower layer, to the application software layer 110. Furthermore, the runtime environment 130 provides a communication mechanism between the components of the application software that exist in the application software layer 110. That is, the runtime environment 130 functions as a communication center which controls the exchange of data between the components of the application software layer 110 and between the components of the application software layer 110 and the BSW layer 150 and controls the exchange of data between components mounted on different ECUs.

The BSW layer 150 abstracts ECU hardware and a microcontroller and provides the application software layer 110 with basic service, that is, a common function. First, the BSW layer 150 provides the application software layer 110 with the service layer 151 for providing basic services specified in the AUTOSAR standard. The service layer 151 is partially practically dependent on hardware, such as an ECU and a microcontroller, and embodied, but is embodied to provide a hardware-independent interface to a higher layer. Furthermore, the BSW layer 150 includes the ECU abstraction layer 153 for abstracting an ECU for a higher layer and the microcontroller abstraction layer 155 for processing direct access to peripheral devices, inside and outside devices, and memory that are practically included in hardware.

Meanwhile, in the development methodology part, a series of development methodologies of allowing a developer to design application software, assigning the developed application software to a proper ECU, and setting relevant basic software are defined. The development of AUTOSAR software is divided into a system configuration step and an ECU configuration step. In the system configuration step, an application software component description that describes the data format of an application software component, a connection state with an interface, and an internal behavior, an ECU resource description that describes the hardware configuration of an ECU, and a constraint description regarding a bus signal and a network topology are written. Furthermore, a system configuration description is written by mapping application software to each ECU and designing a network. The written description files may use templates of an eXtensible Markup Language (XML) format so that the sharing and transfer of data is standardized. In the ECU configuration step, an ECU design description is written by extracting information on each ECU from the system configuration description, designing the ECU based on the extracted information, and designing an RTE and BSW. AUTOSAR software module codes, such as RTE communication codes, together with application software, are generated and then produced into an execution file through compilation and link, thereby embodying ECU application service.

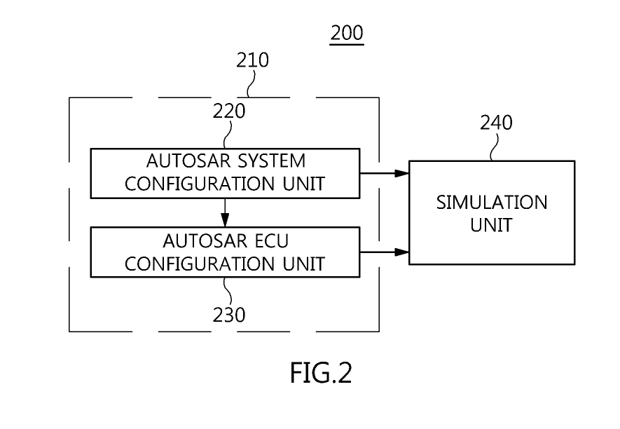

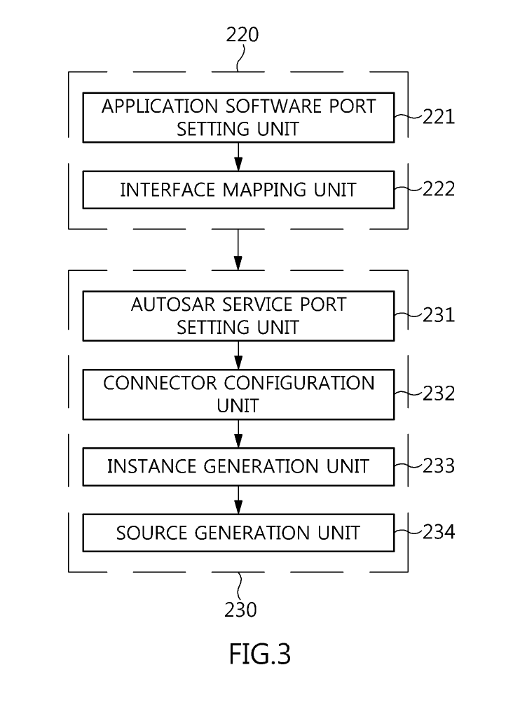

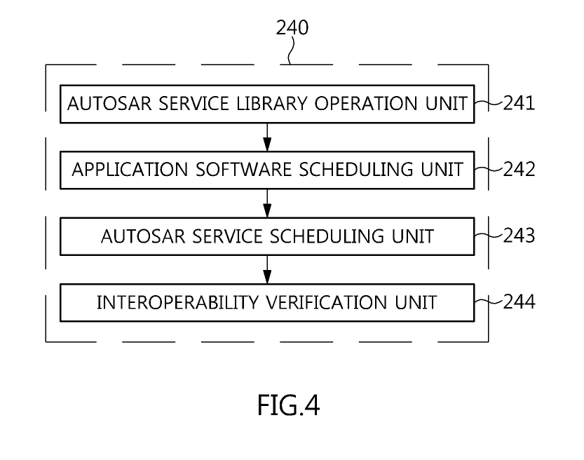

FIG. 2 is a schematic block diagram showing the configuration of an apparatus for verifying interoperability between application software and AUTOSAR services in accordance with the present invention, FIG. 3 is a schematic block diagram showing the configuration of an AUTOSAR interoperability configuration unit which is adopted in the apparatus for verifying interoperability between application software and AUTOSAR services in accordance with the present invention, and FIG. 4 is a schematic block diagram showing the configuration of a simulation unit which is adopted in the apparatus for verifying interoperability between application software and AUTOSAR services in accordance with the present invention.

Referring first to FIG. 2, the apparatus 200 for verifying interoperability between application software and AUTOSAR services chiefly include an AUTOSAR interoperability configuration unit 210 and a simulation unit 240.

The AUTOSAR interoperability configuration unit 210 configures an interoperability relationship between AUTOSAR service components defined to provide the AUTOSAR services and the components of application software for ECUs that perform functions requested by the application software. The AUTOSAR services provided by the AUTOSAR service components correspond to services provided by the service layer 151 of the AUTOSAR software architecture 100 shown in FIG. 1. Furthermore, the AUTOSAR service components may include, for example, a non-volatile random-access memory manager NvM, a watchdog manager WdgM, a diagnostics communication manager DcM, a communication manager ComM, an ECU state manager EcuM, a diagnostics event manager DeM, and a function inhibition manager FiM. The AUTOSAR service components are treated as software components defined in the AUTOSAR standard. This AUTOSAR standard specifies that the AUTOSAR service components and the components of application software developed by a developer are treated as the same layer and to provide interoperability between them is an important function.

The AUTOSAR interoperability configuration unit 210 includes an AUTOSAR system configuration unit 220 for configuring an interoperability relationship between the AUTOSAR service components and the components of the application software and an AUTOSAR ECU configuration unit 230.

The AUTOSAR system configuration unit 220 sets the port of the components of the application software designed for a connection with AUTOSAR service components in a process of a developer designing application software in the system configuration step of the above-described AUTOSAR development methodology part and maps an AUTOSAR standard service interface to the set port of the components of the application software. As shown in FIG. 3, the AUTOSAR system configuration unit 220 may include an application software port setting unit 221 and an interface mapping unit 222. The application software port setting unit 221 sets a port designed to connect the AUTOSAR service components, with the components of the application software for embodying an ECU that performs functions requested by application software designed by a developer in the system configuration step. In this case, the AUTOSAR service components may belong to an AUTOSAR service package which is generated by the AUTOSAR service package generation unit. The interface mapping unit 222 may map the AUTOSAR standard service interface to the set port of the components of the application software. The AUTOSAR system configuration unit 220 provides the mapped results to the simulation unit 240, so that the simulation unit 240 can design logic for the components of the application software and the internal behavior of the logic and simulate the logic and internal behavior.

The AUTOSAR ECU configuration unit 230 sets the port of an AUTOSAR service component designed for a connection with the port of the components of the application software which has been set in the system configuration step and generates a connector for connecting the port of the AUTOSAR service component with the port of the components of the application software, when a basic configuration for an ECU is performed in the ECU configuration step of the AUTOSAR development methodology part. As shown in FIG. 3, the AUTOSAR ECU configuration unit 230 may include an AUTOSAR service port setting unit 231 and a connector configuration unit 232. The AUTOSAR service port setting unit 231 sets the port of the AUTOSAR service component designed for a connection with the port of the components of the application software which has been set by the application software port setting unit 221 of the AUTOSAR system configuration unit 220. The connector configuration unit 232 generates the connector for connecting the port of the components of the application software which has been set by the application software port setting unit 221 with the port of the AUTOSAR service component which has been set by the AUTOSAR service port setting unit 231. Meanwhile, when the port of the AUTOSAR service component is set by the AUTOSAR service port setting unit 231, the basis configuration function of an ECU is to maintain the service component for each ECU by generating the AUTOSAR service component to be connected with the components of the application software.

Meanwhile, the AUTOSAR ECU configuration unit 230 may include an instance generation unit 233 and a source generation unit 234, as shown in FIG. 3. The instance generation unit 233 extracts contents designed for each ECU, performs a basic configuration for the ECU, and generates an instance of the AUTOSAR service component selected for each ECU. The source generation unit 234 generates a source into which the execution attribute value of the generated instance has been incorporated. The source generated by the source generation unit 234 is provided to the simulation unit 240, so that the internal behavior of the AUTOSAR service component is designed.

The simulation unit 240 performs simulations in order to verify whether an interoperability relationship between the configured AUTOSAR service components and the components of the application software is normally driven or not based on scheduled task timing. As shown in FIG. 4, the simulation unit 240 may include an AUTOSAR service library operation unit 241, an application software scheduling unit 242, an AUTOSAR service scheduling unit 243, and an interoperability verification unit 244. The AUTOSAR service library operation unit 241 stores information necessary to operate the AUTOSAR service components and designs the task timing of components of the application software and the AUTOSAR service components based on the stored information. The application software scheduling unit 242 schedules task timing for the logic and internal behavior of the components of the application software based on a result of the mapping of the interface mapping unit 222 so that the logic and internal behavior are simulated. The AUTOSAR service scheduling unit 243 schedules task timing for the internal behavior of the AUTOSAR service components based on the AUTOS AR service library operation unit 241 into which a source generated from the source generation unit 234 has been imported and provides a simulation environment in which the task timing has been simulated. The interoperability verification unit 244 searches for an optimized task timing parameter by performing simulations according to the task timing schedule of the AUTOSAR service components while operating in conjunction with the execution attribute of a simulation for the components of the application software and verifies an interoperability relationship between the components of the application software and the AUTOSAR service components based on the optimized task timing parameter.

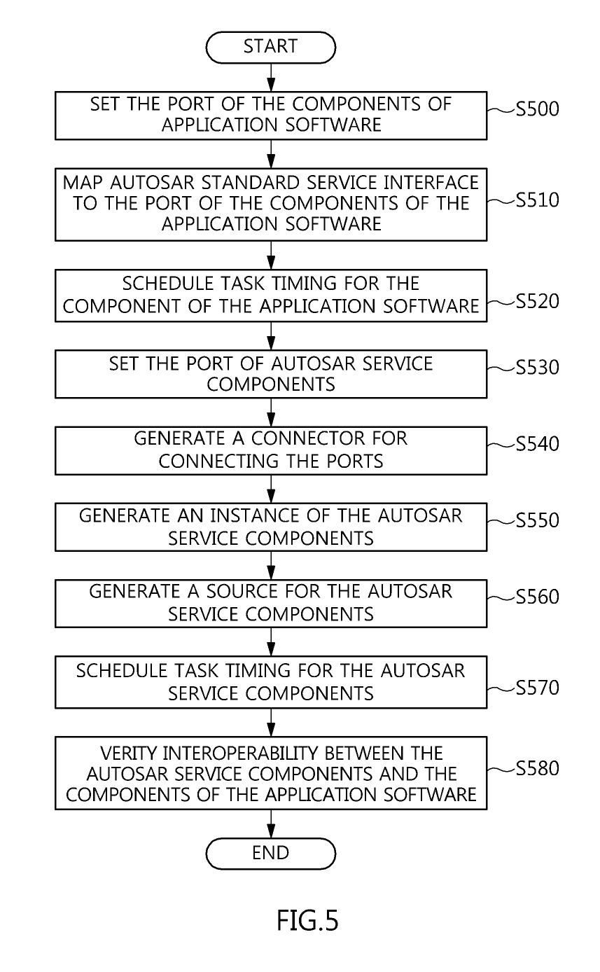

FIG. 5 is a flowchart illustrating a method of verifying interoperability between application software and AUTOSAR services in accordance with the present invention.

Referring to FIG. 5, in the method of verifying interoperability between application software and AUTOSAR services in accordance with the present invention, first, in order to configure an interoperability relationship between AUTOSAR service components defined to provide the AUTOSAR services and the components of application software for an ECU that performs functions requested by the application software, the application software port setting unit 221 of the AUTOSAR system configuration unit 220 sets the port of the components of the application software designed for a connection with the AUTOSAR service components at step S500.

At step S510, the interface mapping unit 222 of the AUTOSAR system configuration unit 220 maps an AUTOSAR standard service interface to the port of the components of the application software which has been set at step S500.

At step S520, the application software scheduling unit 242 of the simulation unit 240 designs and simulates task timing for the logic and internal behavior of the components of the application software based on a result of the mapping at step S510.

At step S530, the AUTOSAR service port setting unit 231 of the AUTOSAR ECU configuration unit 230 sets the port of an AUTOSAR service component designed for a connection with the port of the components of the application software set by the application software port setting unit 231 at step S500.

At step S540, the connector configuration unit 232 of the AUTOSAR ECU configuration unit 230 generates a connector for connecting the port of the components of the application software, set by the application software port setting unit 221 at step S500, with the port of the AUTOSAR service component set by the AUTOSAR service port setting unit 231 at step S530.

Next, the instance generation unit 233 of the AUTOSAR ECU configuration unit 230 generates an instance of the AUTOSAR service component at step S550.

The source generation unit 233 of the AUTOSAR ECU configuration unit 230 configures the execution attributes of the generated instance, generates a source by incorporating the configured execution attribute value into the source, and imports the source into the AUTOSAR service library operation unit 241 of the simulation unit 240 at step S560.

At step S570, the AUTOSAR service scheduling unit 242 of the simulation unit 240 designs task timing for the internal behavior of the AUTOSAR service components based on the imported source at step S560.

At step S580, whether an interoperability relationship between the AUTOSAR service components and the components of the application software is normally driven or not is verified based on the task timing of the components of the application software, simulated for its interoperability at step S520, and the task timing of the designed AUTOSAR service components simulated at step S570, through simulations.

In accordance with the apparatus and method for verifying interoperability between application software and AUTOSAR services according to the exemplary embodiments of the present invention, an interoperability relationship between AUTOSAR services and application software is verified based on scheduled task timing. Thus, there is an advantage in that application software can be verified precisely and particularly because a driving environment similar to an actual environment is provided.

Accordingly, the present invention is advantageous in that an application software developer can develop application software of a high quality easily using various and standardized services provided by the AUTOSAR standard.

While the present invention has been described with respect to the specific embodiments, it will be apparent to those skilled in the art that various changes and modifications may be made without departing from the spirit and scope of the invention as defined in the following claims.

What is claimed is:

1. An apparatus for verifying interoperability between application software and AUTomotive Open System ARchitecture (AUTOSAR) services, the apparatus comprising:
an AUTOSAR interoperability configuration unit configured to configure an interoperability relationship between AUTOSAR service components defined to provide the AUTOSAR services and components of the application software for Electronic Control Unit (ECUs) performing functions requested by the application software; and
a simulation unit configured to perform simulations in order to verify whether the interoperated AUTOSAR service components and the components of the application software are normally driven or not based on scheduled task timing, the scheduled task timing generated based on both of the AUTOSAR service components and components of the application software.

2. The apparatus of claim 1, wherein the AUTOSAR interoperability configuration unit comprises:
an AUTOSAR system configuration unit configured to design the application software; and
an AUTOSAR ECU configuration unit configured to extract information on the ECU from the designed application software and design the ECU based on the extracted information.

3. The apparatus of claim 2, wherein the AUTOSAR system configuration unit comprises an application software port setting unit configured to set a port of the designed application software in order to connect the AUTOSAR service components with the components of the application software.

4. The apparatus of claim 2, wherein the AUTOSAR system configuration unit comprises an interface mapping unit configured to map an AUTOSAR standard service interface to a port of the components of the application software.

5. The apparatus of claim 2, wherein the AUTOSAR ECU configuration unit comprises:
an AUTOSAR service port setting unit configured to set a port of the defined AUTOSAR service components in order to connect the AUTOSAR service components with the components of the application software; and
a connector configuration unit configured to configure a connector for connecting the port of the AUTOSAR service components with a port of the components of the application software.

6. The apparatus of claim 2, wherein the AUTOSAR ECU configuration unit comprises:
an instance generation unit configured to generate an instance of an AUTOSAR service component selected for each ECU; and
a source generation unit configured to generate a source into which an execution attribute value of the generated instance has been incorporated and provide the generated source to the simulation unit.

7. The apparatus of claim 1, wherein the simulation unit schedules task timing for each of internal behaviors of the components of the application software and the AUTOSAR service components based on an AUTOSAR service library operation unit for storing information necessary to operate the AUTOSAR service components and performs simulations based on the scheduled task timings.

8. A method of verifying interoperability between application software and AUTOSAR services, the method comprising:
configuring an interoperability relationship between AUTOSAR service components defined to provide the AUTOSAR services and components of the application software for Electronic Control Units (ECUs) performing functions requested by application software; and
performing simulations in order to verify whether the interoperated AUTOSAR service components and the components of the application software are normally driven or not based on scheduled task timing, the scheduled task timing generated based on both of the AUTOSAR service components and components of the application software.

9. The method of claim 8, wherein configuring an interoperability relationship between AUTOSAR service components defined to provide the AUTOSAR services and the components of the application software for an ECU performing functions requested by application software comprises:
designing the application software; and
extracting information on the ECU from the designed application software and designing the ECU based on the extracted information.

10. The method of claim 9, wherein designing the application software comprises:
setting a port of the designed application software in order to connect the AUTOSAR service components with the components of the application software; and
mapping an AUTOSAR standard service interface to the port of the components of the application software.

11. The method of claim 9, wherein extracting information on the ECU from the designed application software and designing the ECU based on the extracted information comprises:
setting a port of the defined AUTOSAR service components in order to connect the AUTOSAR service components with the components of the application software;
configuring a connector for connecting the port of the AUTOSAR service components with a port of the components of the application software;
generating an instance of an AUTOSAR service component selected for each ECU; and
generating a source into which an execution attribute value of the generated instance has been incorporated and providing the generated source.

12. The method of claim 8, wherein performing simulations in order to verify whether the interoperated AUTOSAR service components and components of the application software are normally driven or not based on scheduled task timing comprises:
scheduling task timing for each of the internal behaviors of the components of the application software and the AUTOSAR service components based information necessary to operate the AUTOSAR service components; and
performing the simulations based on the scheduled task timings.
